(19) United States
(12) Patent Application Publication
(10) Pub. No.: US 2012/0234790 A1
(43) Pub. Date: Sep. 20, 2012

(54) BABY BOTTLE

(76) Inventor: OFER GOLLAN, Hadera (IL)

(21) Appl. No.: 13/417,258

(22) Filed: Mar. 11, 2012

(30) Foreign Application Priority Data
Mar. 14, 2011 (IL) 211715

(51) Int. Cl. A61J 9/00; B65D 21/08; A61J 11/00

(52) U.S. Cl. 215/365; 215/10

(57) ABSTRACT

A baby bottle (10) comprising: a vessel (12) ending with a substantially smooth wall (20) at the top thereof; and a teat (50) comprising two circumferential arms (26A, 26B) splitting at the bottom thereof, the arms (26A, 26A) disposed parallel to the wall (20) elastically embracing the wall (20) in a sealed manner, wherein each of the arms (26A, 26B) comprises a circumferential protrusion (18) bending towards the wall (20) of the cup (12), for enhancing the elastic embracing, and slowing amortization of the teat (50), and wherein the vessel (12) is formed as a cone, allowing packing a plurality of vessels of the same form in a compact manner, thereby allowing packing a plurality of vessels (12) in a compact, disposable and sterile form for use with the teat (50).

### FIELD OF THE INVENTION

The present invention relates to the field of baby bottles. More particularly, the invention relates to a baby bottle having sterilized features.

### BACKGROUND OF THE INVENTION

A baby bottle includes a vessel commonly made of polycarbonate, a teat commonly made of liquid silicone rubber or natural rubber, and a coupling which couples the vessel to the teat in a leak-proof manner.

Prior art baby bottles can be sterilized by boiling in hot water. However, these bottles are difficult to sterilize in boiling water due to their tendency to float.

Thus, practically, baby bottles are not sterilized but rather are only cleaned with hot soapy water.

The mouth of the bottles is narrower than of the vessels themselves, thus, washing too is difficult and usually insufficiently performed.

Disposable bottles were introduced. However, the structure of these bottles makes them relatively expensive since the sealing requires sealing elements of both the vessel and the teat.

For example, U.S. Pat. No. 3,777,753 discloses a teat for feeding bottles for babies. The teat has a nipple portion for being fitted upon a bottle neck so as to grip around the latter. The bottle is gripped between a sealing lip and a cylindrical wall of the teat.

However, this gripping assumes that the bottle includes a thread or an oblique sealing lip. Thus, this bottle is not suited for being disposable.

All the methods described above have not yet provided satisfactory solutions neither to the problem of washing and sterilizing baby bottles, nor to manufacturing of inexpensive disposable baby bottles.

It is an object of the present invention to provide a method and apparatus for providing sterilized baby bottles.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a baby bottle (10) comprising:
a vessel (12) ending with a wall (20) at the top thereof,
a teat (50) comprising two arms (26A, 26B) splitting at the bottom thereof, the arms (26A, 26A) disposed parallel to the wall (20) elastically embracing the wall (20) in a sealed manner,
thereby the sealing is substantively based on sealing elements of the teat (50) only,
thereby the vessel (12) may constitute a common element.

Each of the arms (26A, 26B) may comprise a protrusion (18) bending towards the wall (20) of the cup (12), thereby enhancing the elastic embracing.

The protrusion (18) of at least one of the arms (26B) may comprise bending towards a folded edge (52) of the wall (20), thereby the protrusion (18) prevents sliding of the vessel (12) out of the teat (50).

The vessel (12) may be formed as a cone, allowing packing a plurality of vessels of the same form in a compact manner,

thereby allowing packing a plurality of baby bottles (10) in a compact, disposable and sterile form.

The vessel (12) may be foldable, for allowing packing a plurality of vessels of the same form in a compact manner, thereby allowing packing a plurality of baby bottles (10) in a compact, disposable and sterile form.

The foldability of the vessel (12) may comprise a member selected from a group including: a bellows form diminishing the height, foldability diminishing the width.

The vessel (12) may comprise transparent zones (14) for viewing the contents level.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 depicts a baby bottle according to one embodiment of the present invention.

FIG. 2 depicts the baby bottle of FIG. 1 as marketed.

FIG. 3 is a sectional side view of the baby bottle of FIG. 1.

FIG. 4 depicts a baby bottle according to another embodiment of the present invention.

FIG. 5 is a sectional side view of the baby bottle of FIG. 4.

FIG. 6 is a sectional side view of the baby bottle of FIG. 4 according to another embodiment.

FIG. 7 depicts the bellows form of the vessel of FIG. 4.

FIG. 8 depicts a bellows form according to another embodiment of the present invention.

FIG. 9 depicts a baby bottle according to another embodiment of the present invention.

FIG. 10 is a sectional side view of the baby bottle of FIG.

FIG. 11 is a sectional side view of the baby bottle of FIG. 7 or other bottles, indicating additional features.

FIG. 12 depicts the baby bottle having the transparent zones of FIG. 11.

FIG. 13 is a sectional side view of the baby bottle of FIG. 1 according to another embodiment.

FIG. 14 is a sectional side view of the baby bottle of FIG. 1 according to another embodiment.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The solution disclosed by the present invention to the above-mentioned problems is attaching a non-disposable teat to a disposable vessel.

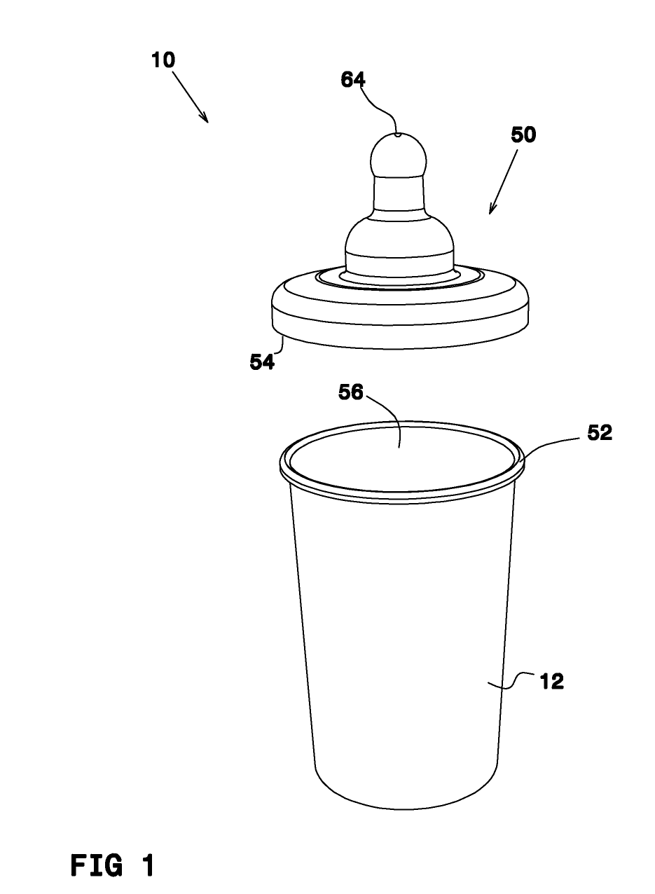

FIG. 1 depicts a baby bottle according to one embodiment of the present invention.

Baby bottle 10 of the present invention includes a disposable vessel 12 for being substituted, and a non-disposable teat 50 for drinking the formula therethrough.

The formula is poured into disposable vessel 12 through mouth 56 thereof, and teat 50 then covers vessel 12 in a sealed manner, for drinking through a hole 64 of teat 50.

Unlike the prior art vessel of the baby bottle that is made of polycarbonate, disposable vessel 12 is preferably made of paper or a disposable plastic. Non-disposable teat 50 may also be made of liquid silicone rubber or natural rubber like the prior art teats.

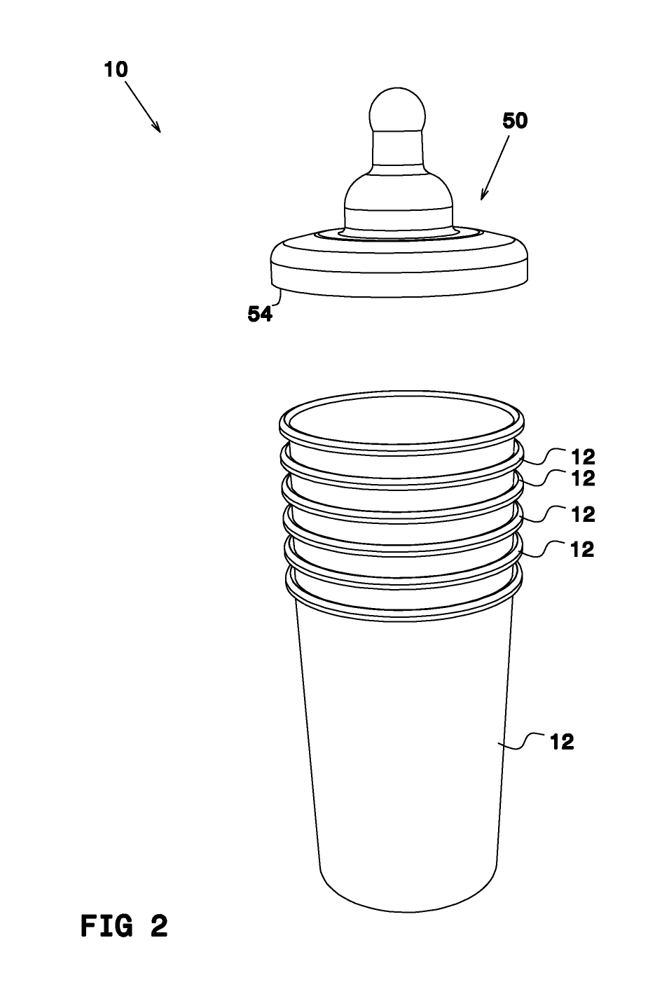

FIG. 2 depicts the baby bottle of FIG. 1 as marketed.

Disposable vessels 12 may be designed to be compactly packaged together. A large amount of disposable vessels 12 may thus be compactly packaged together for marketing thereof, or with one non-disposable teat 50, or a small number of teats.

According to one embodiment, the compact design may feature a widening shape from bottom to top, as depicted in FIG. 2, like common disposable vessels, for inserting one vessel inside the other.

Thus, unlike the prior art baby bottles which require cleaning and sterilizing the vessels, disposable vessels 12 may be marketed clean and sterilized for a single use of each.

This embodiment is disadvantaged of requiring a non-standard teat.

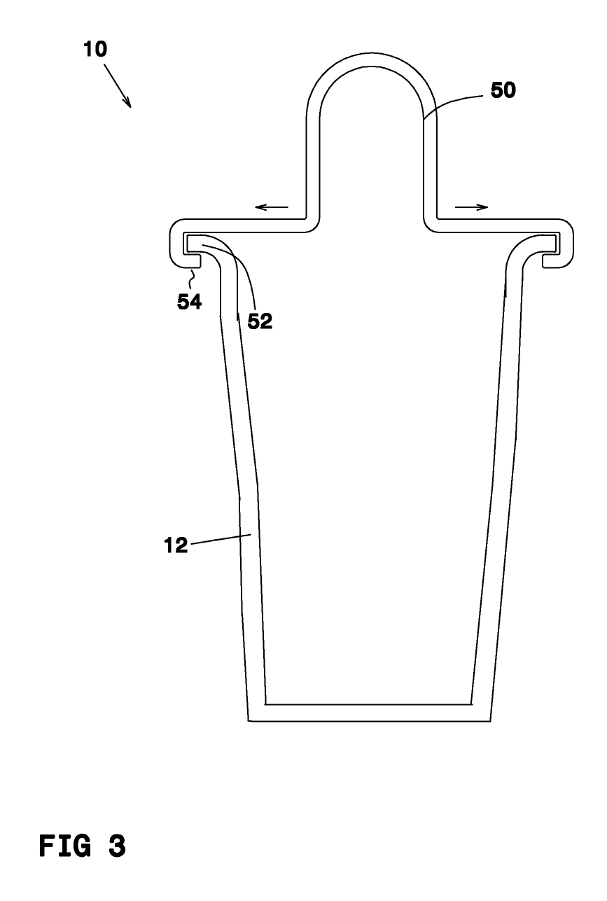

FIG. 3 is a sectional side view of the baby bottle of FIG. 1.

Baby bottle 10 is leak-proof due to contact between surrounding complementary edge 52 of vessel 12 and edge 54 of teat 50.

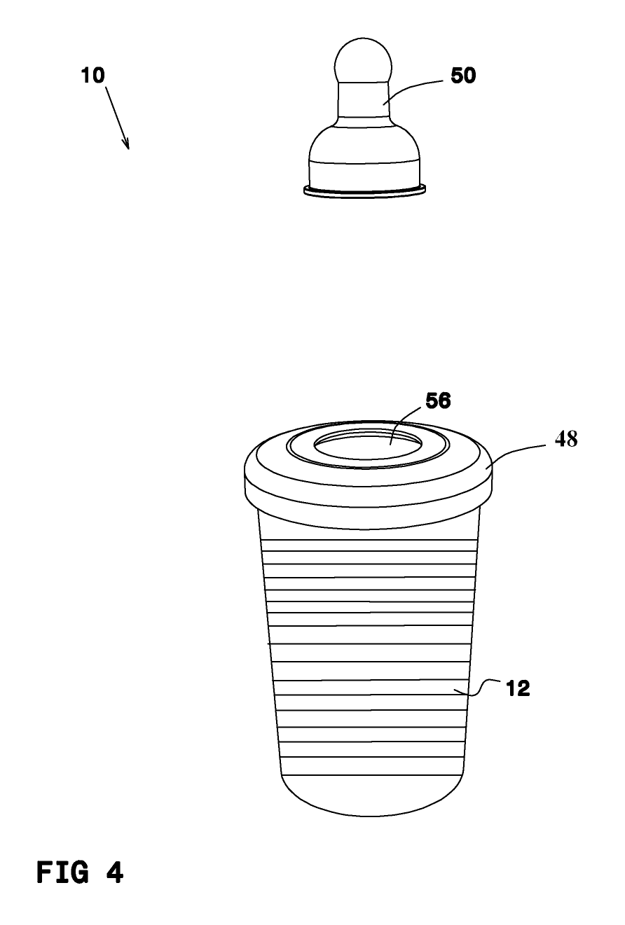

FIG. 4 depicts a baby bottle according to another embodiment of the present invention.

According to this embodiment, disposable vessel 12 includes a top 48 having a narrow mouth 56, which may fit the size of a standard teat. This thus allows using a standard teat 50.

According to one embodiment, top 48 is inherent within disposable vessel 12.

The embodiment of FIG. 4 provides packaging of many vessels 12 together by providing vessel 12 a bellows form.

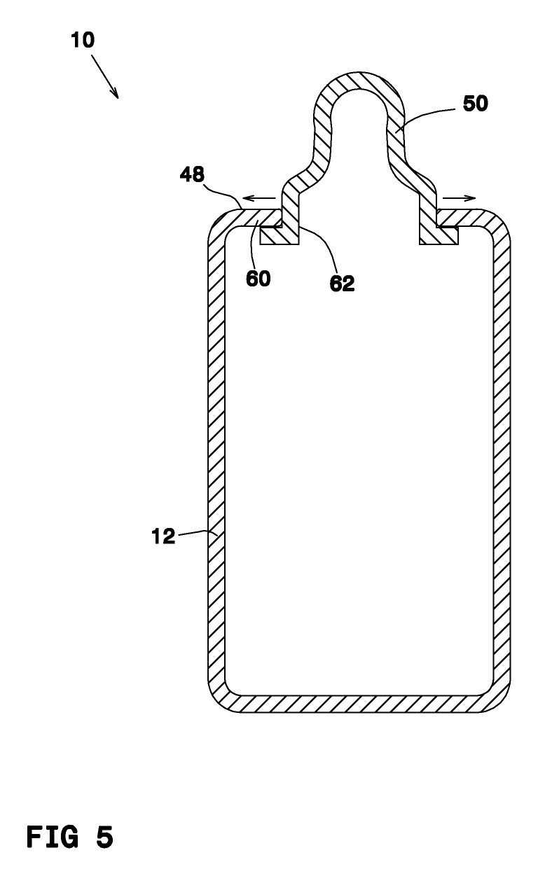

FIG. 5 is a sectional side view of the baby bottle of FIG. 4.

Baby bottle 10 is leak-proof due to contact between surrounding edges 60 and 62 of top 48 and of teat 50 respectively, which is based on the springy feature of teat 50.

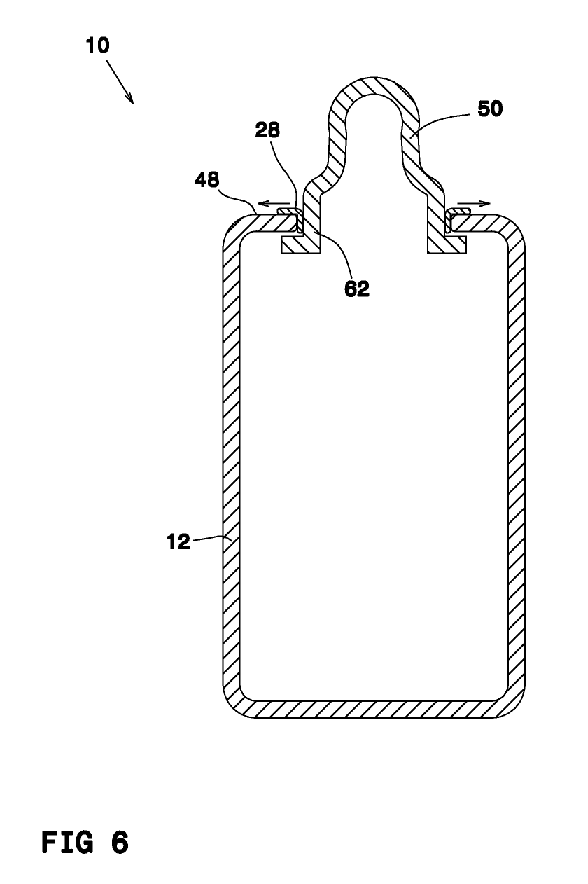

FIG. 6 is a sectional side view of the baby bottle of FIG. 4, according to another embodiment.

Since mouth 56 of disposable vessel 12, made of paper or plastic, is not firm, a firm mouth 28 may be attached to mouth 56 of vessel 12 in a sealed manner, for avoiding bending mouth 56 of vessel 12. Firm mouth 28 is thus sealed to teat 50. Firm mouth 28 is disposable, together with vessel 12.

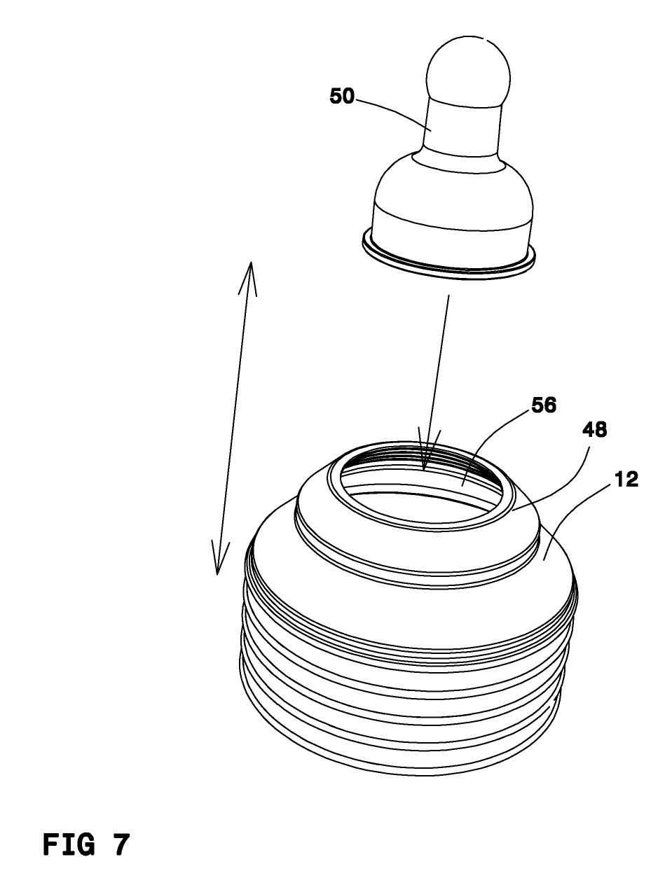

FIG. 7 depicts the bellows form of the vessel of FIG. 4.

According to another embodiment, the compact design may feature foldability provided by a bellows form.

In order to allow packaging many vessels 12 together, each vessel 12 is foldable, diminishing the height thereof.

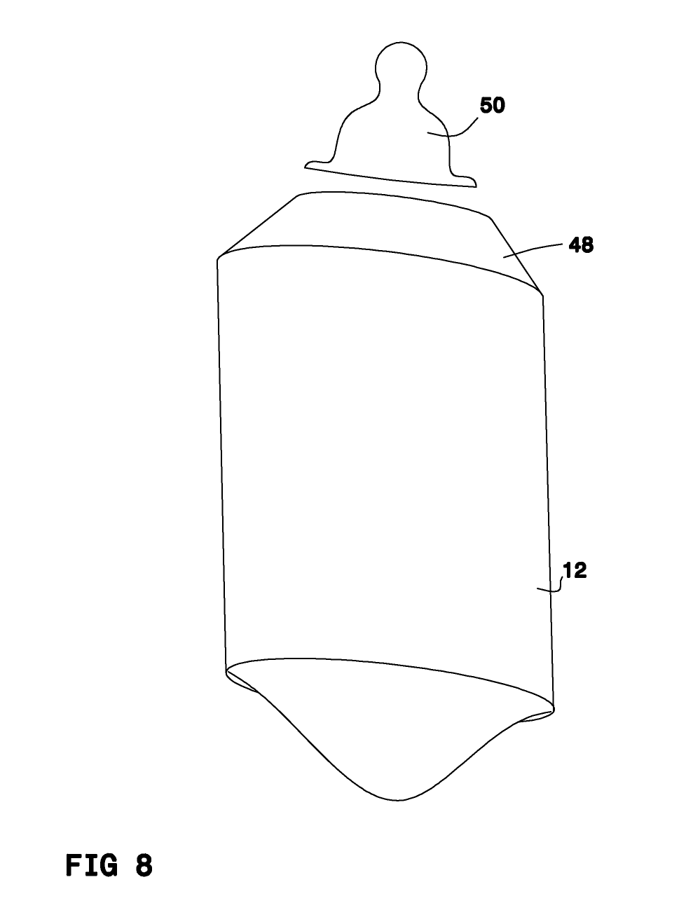

FIG. 8 depicts a bellows form, according to another embodiment of the present invention.

According to another embodiment, each vessel 12 is foldable, diminishing the width thereof.

The embodiments of FIGS. 4 to 8 are disadvantaged of a small mouth 56, thus, pouring the formula may not be convenient.

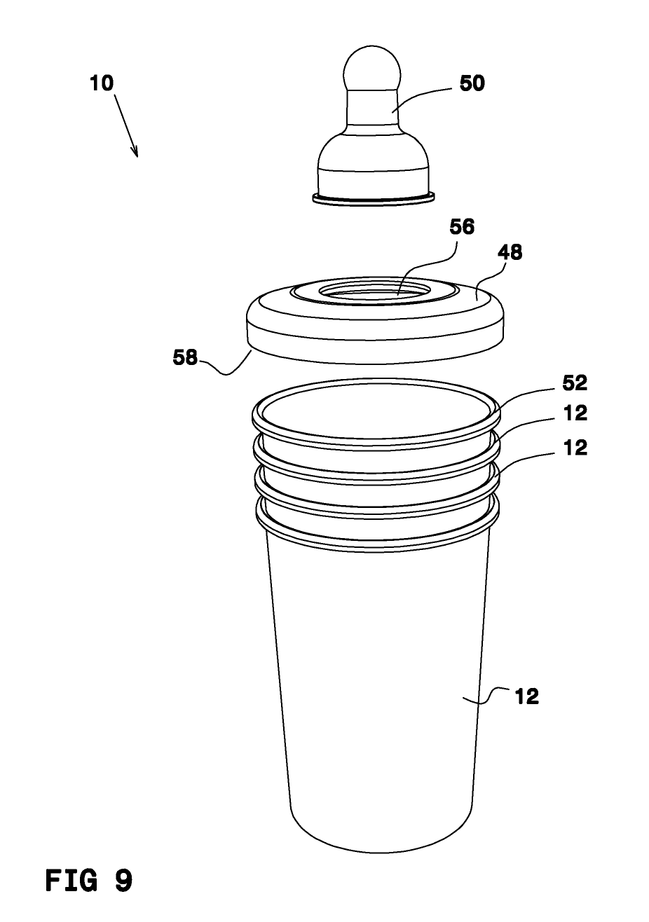

FIG. 9 depicts a baby bottle according to another embodiment of the present invention.

Unlike the embodiment wherein top 48 is inherent within disposable vessel 12, according to the embodiment of FIG. 9, top 48 is a coupling, which is separate from vessel 12, for being coupled to vessel 12 and to teat 50. According to this embodiment, mouth 56 may also be sized to fit a standard teat of a baby bottle. Coupling 48 thus functions as a coupling for coupling non-disposable teat 50 to disposable vessel 12.

This embodiment allows using a standard teat 50. Also, this embodiment provides the packaging feature depicted in FIG. 2. Further, pouring the formula may be performed through the mouth of vessel 12, which is sufficiently large.

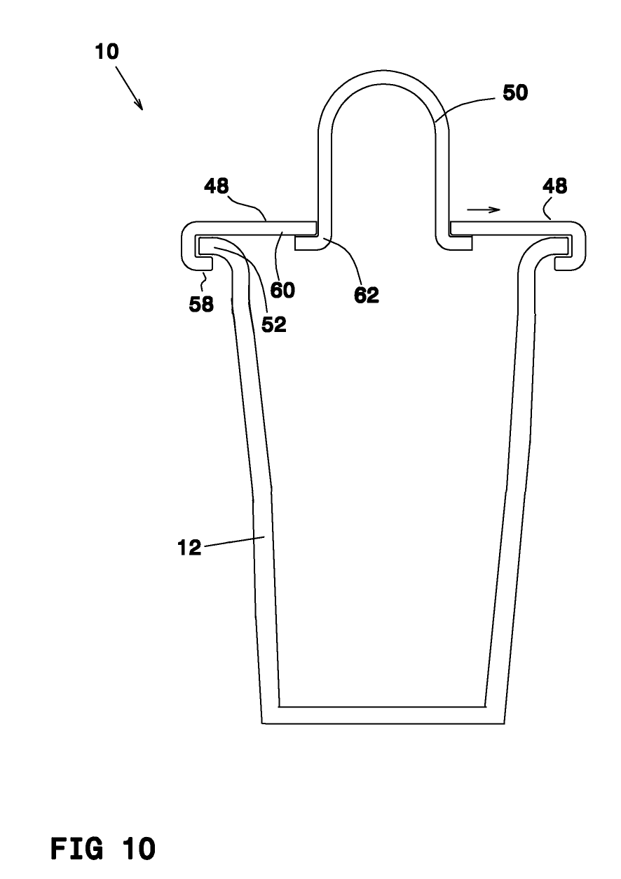

FIG. 10 is a sectional side view of the baby bottle of FIG. 9.

Baby bottle 10 is leak-proof due to contact between surrounding complementary edges 52 and 58 of vessel 12 and of coupling 48, respectively.

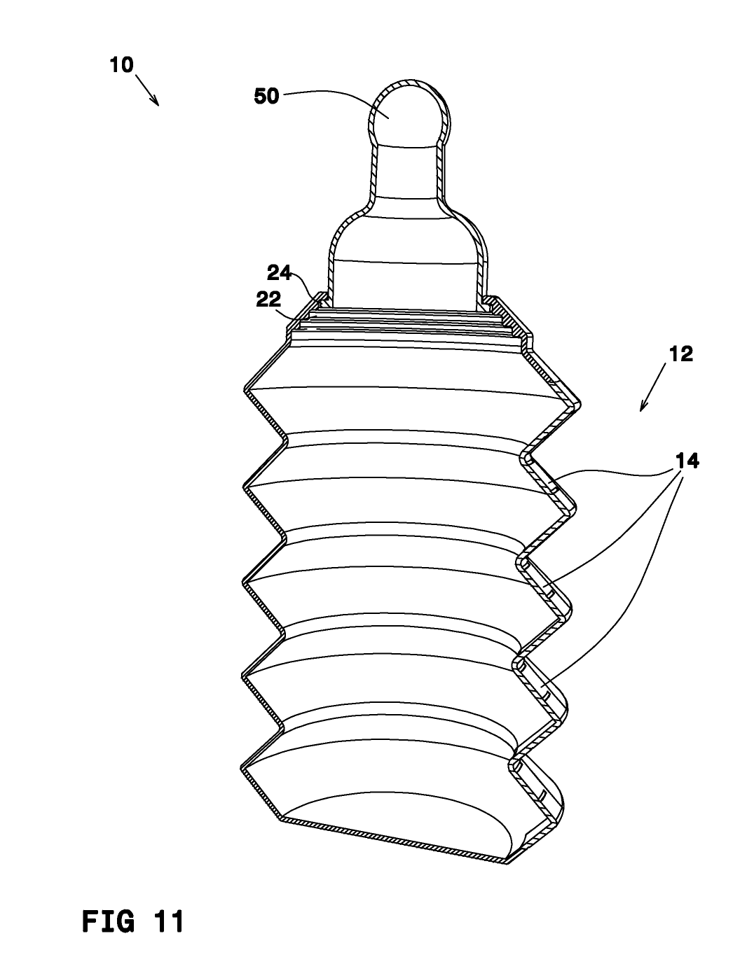

FIG. 11 is a sectional side view of the baby bottle of FIG. 7 or other bottles indicating additional features.

Vessel 12 may be designed for fitting several standards of teats 50. For example, each of depressions 22 and 24 of disposable vessel 12 may fit a different size of a teat.

Vessel 12 may include notches and transparent zones 14 for viewing and measuring the water level.

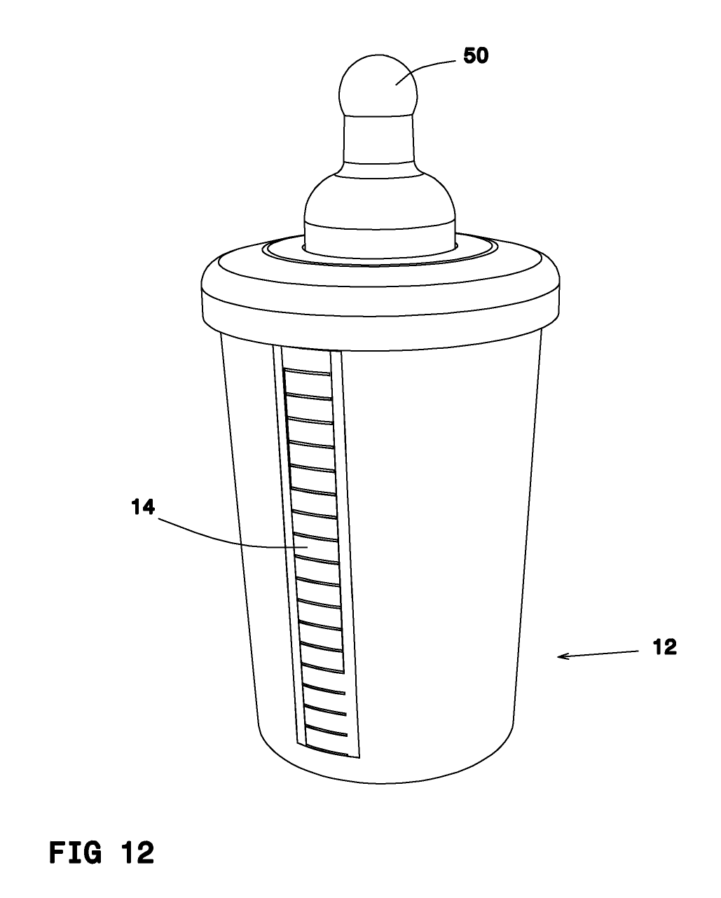

FIG. 12 depicts the baby bottle having the transparent zones 14 of FIG. 11.

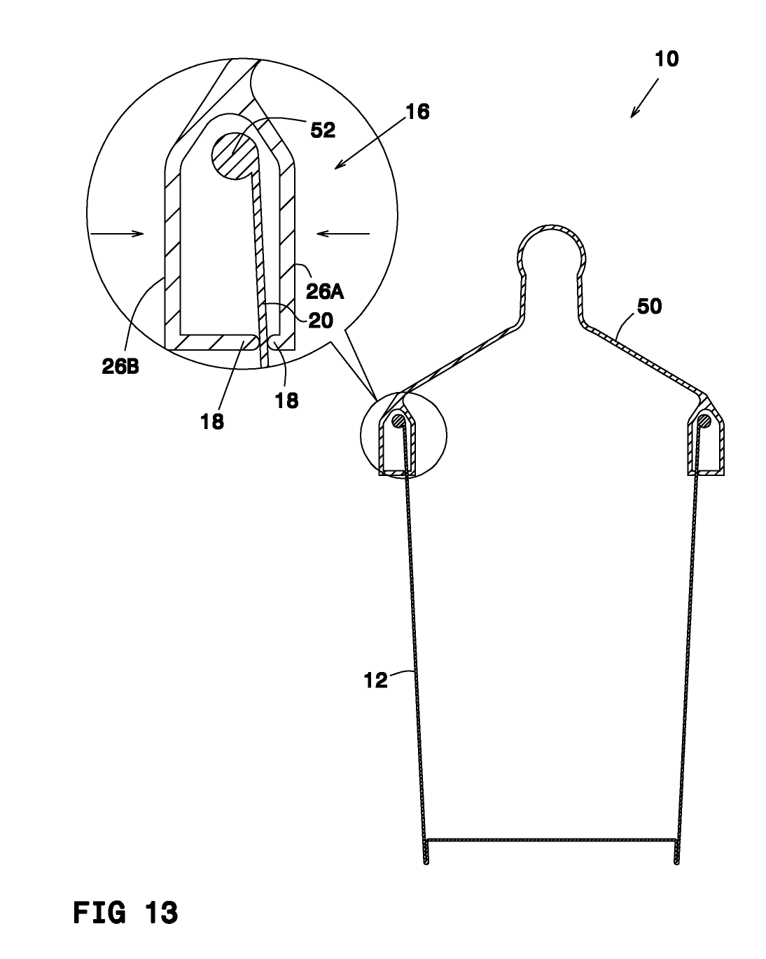

FIG. 13 is a sectional side view of the baby bottle of FIG. 1 according to another embodiment.

According to this embodiment baby bottle 10 is leak-proof due to contact between surrounding wall of vessel 12 and arms 26A and 26B splitting from teat 50.

Since the sealing is based on sealing elements 26A and 26B of teat 50 only, baby bottle 10 may include a disposable vessel 12 for being substituted, and a non-disposable teat 50.

Arms 26A and 26B are disposed parallel to the wall 20 of vessel 12, forming a fork 16 embracing wall 20 inside and outside it.

The sealing is not based on edge 52 of vessel 12, but only on wall 20 of vessel 12, which is commonly formed smooth and thus suits the sealing of the present embodiment.

Preferably, not the surface of arms 54 seal, but rather protrusions 18 of each arm 54 which are bent towards wall 20 make the sealing. Thus the springy feature of the material of teat 50 presses protrusions 18 onto wall 20, enhancing the sealing between arms 54 and wall 20.

According to a preferred embodiment vessel 12 may be a standard inexpensive (e.g. 10 cents) disposable cup, preferably a paper cup (coffee cup) withstanding heat. Edge 52 at the top of a standard paper cup includes a fold or a roll of the paper.

This folded edge 52 of vessel 12 is inserted within fork 16 of teat 50 sealing the connection.

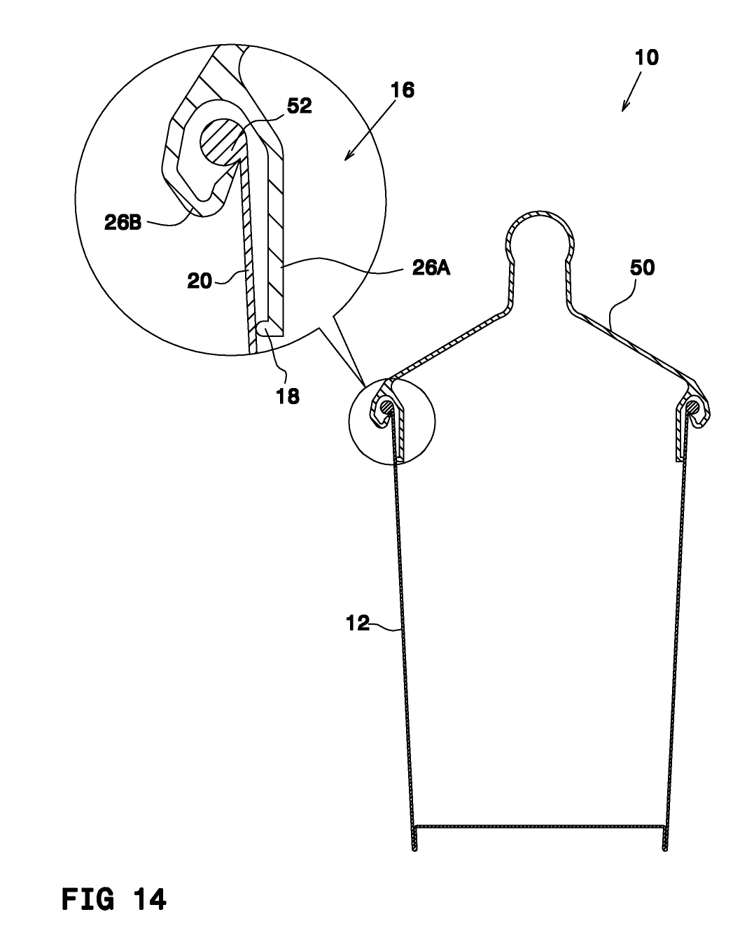

FIG. 14 is a sectional side view of the baby bottle of FIG. 1 according to another embodiment.

According to this embodiment fork 16 provides also a mechanical barrier from vessel 12 sliding out. Arm 26B is bent not only to press wall 20 but also towards folded edge 52 of vessel 12.

Edge 52 at the top of the standard paper cup which includes the fold is trapped by the bent edge 54B upon inserting edge 52 of vessel 12 therein.

In the figures and/or description herein, the following reference numerals have been mentioned:
numeral 10 denotes a baby bottle according to one embodiment of the present invention;
numeral 12 denotes a disposable vessel;
numeral 14 denotes a transparent zone;
numeral 16 denotes a fork formed at the edge of a teat;
numeral 18 denotes protrusions
numeral 20 denotes a wall of the vessel;
numerals 22 and 24 denote depressions within the disposable vessel, each for fitting a different size of teat;
numerals 26A and 26B denote arms of the teat;
numeral 28 denotes a firm mouth, attached to the inherent mouth of the vessel;
numeral 48 denotes a top of the vessel having a narrow mouth; top 48 may be an inherent or a separate coupling; numeral 50 denotes a teat;
numeral 52 denotes an edge of the vessel;
numeral 54 denotes an edge of the teat;
numeral 56 denotes the mouth of the vessel, or the top thereof,
numeral 58 denotes the edge of the coupling;
numeral 60 denotes the edge of the top;
numeral 62 denotes the edge of the teat; and
numeral 64 denotes a hole of the teat.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A baby bottle (10) comprising:
a vessel (12) ending with a substantially smooth wall (20) at the top thereof; and
a teat (50) comprising two circumferential arms (26A, 26B) splitting at the bottom thereof, said arms (26A, 26A) disposed parallel to said wall (20) elastically embracing said wall (20) in a sealed manner,
wherein each of said arms (26A, 26B) comprises a circumferential protrusion (18) bending towards said wall (20) of said cup (12), for enhancing said elastic embracing, and slowing amortization of said teat (50), and
wherein said vessel (12) is formed as a cone, allowing packing a plurality of vessels of the same form in a compact manner, thereby allowing packing a plurality of vessels (12) in a compact, disposable and sterile form for use with said teat (50).

2. A baby bottle (10) according to claim 1, wherein said protrusion (18) of at least one of said arms (26B) comprises bending towards a folded edge (52) of said wall (20),
thereby said protrusion (18) prevents sliding of said vessel (12) out of said teat (50).

3. A baby bottle (10) according to claim 1, wherein said vessel (12) is foldable, for allowing packing a plurality of vessels of the same form in a compact manner,
thereby allowing packing a plurality of baby bottles (10) in a compact, disposable and sterile form.

4. A baby bottle (10) according to claim 3, wherein said foldability of said vessel (12) comprises a member selected from a group including: a bellows form diminishing the height, foldability diminishing the width.

5. A baby bottle (10) according to claim 1, wherein said vessel (12) comprises transparent zones (14) for viewing the contents level.
